(19) United States
(12) Patent Application Publication
(10) Pub. No.: US 2004/0051625 A1
(43) Pub. Date: Mar. 18, 2004

(54) Apparatus for remote interrogation and/or remote control of an operating state of a device, especially a household appliance

(76) Inventors: Peter Nass, Mainz (DE); Kurt Schaupert, Hofheim (DE)

Correspondence Address: STRIKER, STRIKER & STENBY, 103 East Neck Road, Huntington, NY, 11743, US

(21) Appl. No.: 10/612,797

(22) Filed: Jul. 2, 2003

(30) Foreign Application Priority Data
Jul. 6, 2002 (DE) 102 30 476.9

(51) Int. Cl. H04Q 1/00

(52) U.S. Cl. 340/5.31; 340/5.61

(57) ABSTRACT

With the apparatus according to the invention remote interrogation and/or remote control of operating states of a device (1), especially a household appliance or entertainment device, by a data service station (3) remote from the device occurs with a temporary telephone connection between the data service station and a data interface of the device. According to a first embodiment of the invention the apparatus includes an infrared data interface (2) provided in the device (1) and a commercially available mobile telephone (5) provided with an infrared interface (6) for data transmission. The mobile telephone (5) with the infrared interface (6) provides the temporary telephone connection for the remote interrogation and/or remote control. Alternatively the infrared data interface can be replaced by a radio transmitter operating according to the “Bluetooth” principle and the mobile telephone can have a “Bluetooth” interface.

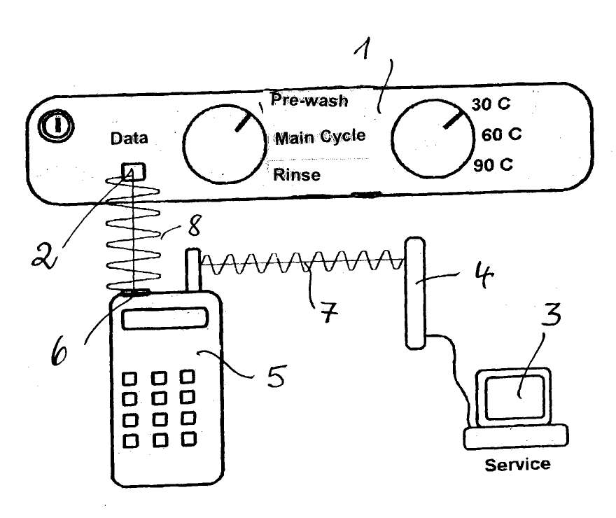

### BACKGROUND OF THE INVENTION

The invention relates to an apparatus for remote interrogation and/or remote control of operating states of a device by a data service station separated spatially, i.e. remote, from the device by means of a-temporary telephonic connection between the data service station and an interface of the device.

Diagnosis of defective or malfunctioning devices, especially household appliances, such as a dishwasher, washing machine, drier, spin drier, heat control and the like, and repair of these devices by customer service is of increasing importance. On the one hand, the number of these devices has greatly increased and, on the other hand, they are ever more complex with highly automated control devices and thus required trained specialists for diagnosis and repair.

Today to an increasing extent in case of trouble with these devices the customer needs customer technical service to come to the location of the device to exactly determine the cause of the malfunction or fault and to repair the device. Usually determination of the cause of the fault or malfunction of the device is too much for the customer. As a result the customer cannot supply any usable information regarding the problem to the customer technical service. Since the customer technical service cannot generally carry all types of replacement parts to the site where the device is located, usually the customer technical service personnel must return a second time to the site in order to repair the device by elimination of the fault. However this makes the cost of the repair very expensive because of rising costs for travel to the site of the repair.

In order to simplify the analysis of the problem or fault, leading manufacturers of so-called household appliances are providing and also switching over to interfaces, typically optical interfaces, in the controllers, by which fault or malfunction condition parameters and system conditions can be read, analogous to diagnostic systems for passinger cars. For that purpose typically a laptop with special software is used. In the case of a service call however a trained service professional must still come to the site where the device is located, i.e. the problem of travel cost increases remains present.

Industry has worked on the possibility of “networking” a household for many years, i.e. to provide the prerequisites for connecting all household appliances and devices with each other so that they can communicate with the outside world by means of the internet. Thus household devices could be connected individually, or by interconnection in the networked house, with the internet and thus data could then be transmitted to the service engineer in customer service.

However the prerequiste for this is the presence in the house of an infrastructure of a wireless network (DECT, Bluetooth) or a wire network (Powerline, Ethernet), which is also connected to the outside world by means of a modem. This can be realized by means of the Internet.

An apparatus for remote interrogation and control of an operating state of a household appliance is described in DE 199 49 314 A1. This apparatus has an acoustic interface, an acoustic coupler, between the household appliance or device and a data processor at the remotely located customer service. The acoustic interface comprises an acoustic component connected with a microprocessor controller of the device, on the device side, and a telephone device, on the connection side. The acoustic component is supplied by an oscillator and microphone on the operator's panel. After the operator contacts the customer technical service by telephone, the telephone receiver is held to the place on the operator's panel where the oscillator and microphone are located. After that acoustic communication occurs between the data processor at customer technical service and the household appliance, i.e. data is read and input to the device, so that a fault or malfunction analysis and, in the case of software errors even a remote repair, can be performed remotely. In this latter case technical service personnel do not need to travel to the location of the device for diagnosis of the trouble with the device.

This known principle of remote interrogation/control by telephone permits pre-diagnosis of malfunctions or faults in a device, especially a household appliance, with requiring technical service personnel to travel to the site where the device is located. Furthermore no additional cables or other infrastructure are required as in networking methods involving the internet. The preliminary or pre-diagnosis of the malfunctions or faults can be performed rapidly and economically. Simple faults can already be eliminated in this manner. Furthermore the engineer of the customer technical service can already have an idea regarding the malfunction or fault in the case of service and the required replacement part can be prepared. Furthermore it is possible to input additional or modified software into the device without specially trained personnel traveling to the site at which the device is located.

The performance of the known methods with an acoustic coupler, in which an optical coupling is explicitly excluded, is however comparatively troublesome because of the interference or noise in the sound waves traveling through the device on the open path for the sound waves. The resulting sound signal produced by the sonic transducer/generator is comparatively noisy. Another disadvantage is that the data transmission rate is very small because of the low frequencies of the acoustic waves transmitted over the telephone. Under practical conditions this data transmission rate is between 0.3 kbit/s and 2.4 kbit/s. Also it is comparatively expensive to equip the device with an acoustic coupler. Furthermore the path for the sound waves must be very carefully and exactly aligned.

### SUMMARY OF THE INVENTION

It is an object of the present invention to provide a device or an appliance of the above-described kind with a remote interrogation and/or remote control device for data by telephone, so that a trouble-free or noise-free rapid data exchange is possible with minimal expense.

This object is attained by a device for remote interrogation and/or remote control of operating states of a device or appliance, especially a household appliance, by a remotely located service station by means of a temporary telephone connection between a data interface of the device or appliance and the service station according to the invention, in which the device or appliance has an infrared data interface and a commercial mobile phone with an infrared interface for data transmission for the telephonic connection.

Alternatively the device, especially a household appliance, has a data transmitter operating according to a “Bluetooth” principle and a commercial mobile phone with a “Bluetooth” interface for data transmission for making the telephonic connection.

According to the invention the control of the device, especially a household appliance, is provided with an interface, which can exchange data with a commercial mobile telephone.

The expense of the telephonic data exchange according to the invention is comparatively small, because numerous devices of leading manufacturer have infrared interfaces and mobile telephones are available in many households, which have infrared interfaces for data transmission. Also mobile telephones with short-range data transmission by radio waves (“Bluetooth”) will be available in the future.

The transmissions are comparatively very noise-free since the infrared path is almost completely free of any interference from surrounding light. This is also true for the path of the radio waves. Also the data transmission rates are significantly higher than those of the prior art. In mobile telephones with an infrared interface the established IR data rate standard in asynchronous serial transmission is already a data rate of 115.2 kb/s. Also in mobile telephone operation according to the “Bluetooth” principle the data rate of 108 kb/s is substantially higher than in acoustic coupling.

In the case of malfunction or fault the customer then calls the customer technical service with the mobile telephone and is instructed to place the mobile telephone in the vicinity of the device to be tested. In the case of a mobile telephone with an infrared interface the spacing may be 1 m, typically 2 m. In the case of a “Bluetooth” mobile telephone the transmission is about several meters. The engineer can then perform an error or fault diagnosis and correct, as needed, operating errors or software mistakes.

The system according to the invention is applicable to household appliances, such as cooking ranges, baking ovens, spin dryers, washing machines, dryers, fitness devices and heating plants. Commercial devices in these fields, such as devices for food preparation and refrigeration devices, produce substantially higher damage than household devices because of out-of-service time and the larger volume of food in them, when they malfunction or have operating trouble. The rapid malfunction or fault diagnosis and repair provided by the system according to the invention is especially advantageous in the case of these latter commercial devices and with fitness equipment. Furthermore the system can be used for electronically controlled laboratory devices or devices (laboratory ovens, if necessary with stirrers).

In other embodiments of the invention the customer can communicate with an internet site of the manufacturer with a WAP-capable mobile telephone. Then information, such a software updates, new graphic surfaces, acoustic signals (“special signal tones”), expanded operating functions (wash programs, back programs) or cooking recipes can be loaded and transmitted to the household appliance with this mobile telephone.

In an additional embodiment of the apparatus the customer can arrange the transmission of programming for a television or video recorder from the manufacturer or technical service department, without personnel traveling to the site of the device.

The remote diagnosis or testing of photovoltaic equipment (charge state, sunshine duration, operational hour number) similarly occurs by means of the system according to the invention. In another embodiment of the system according to the invention a remote testing or diagnosis of a malfunction of a passenger car can occur and can be transmitted-to a repair service.

### BRIEF DESCRIPTION OF THE DRAWING

The objects, features and advantages of the invention will now be illustrated in more detail with the aid of the following description of the preferred embodiments, with reference to the sole FIGURE showing a diagrammatic view of an embodiment of the apparatus according to the claimed invention.

### DETAILED DESCRIPTION OF THE INVENTION

The FIGURE shows data exchange between a washing machine, which is symbolically indicated with operator's panel 1, and an infrared interface 2 with a modern processor controller, and a data processor 3 with telephone 4 in the customer technical service. A commercial mobile telephone 5 with an infrared interface 6 is used for telephone transmission of the data. The telephone connection 7 between the service provider and the mobile telephone 5 is handled over the open network.

In operation the apparatus operates as follows during the case of service: A user finds that the washing machine 1 has a malfunction or fault. The washing machine, for example, remains standing with a filled drum during the wash process. The exact cause is unclear and mechanical or electrical parts are damaged. The user calls the service 3 of the appliance manufacturer and places the mobile telephone 5 next to the appliance to construct an infrared data path 8—as shown. Data can then be directly exchanged between the service station 3 and the controller of the washing machine.

The disclosure in German Patent Application 102 30 476.9-32 of Jul. 6, 2002 is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in an apparatus for remote interrogation and/or remote influence of an operating state of a device, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

We claim:

1. An apparatus for remote interrogation and/or remote control of operating states of a device (1) by a data service station (3) remote from the device with a temporary telephone connection between the data service station and a data interface of the device, wherein said apparatus comprises an infrared data interface (2) provided in the device (1) and a commercially available mobile telephone (5) provided with an infrared interface (6) for data transmission, said mobile telephone (5). with said infrared interface (6) providing means for making the temporary telephone connection for the remote interrogation and/or remote control.

2. The apparatus as defined in claim 1, wherein the device is a household appliance or household entertainment device.

3. The apparatus as defined in claim 1, wherein the device is a heating plant for a house.

4. The apparatus as defined in claim 1, wherein the device is an apparatus for producing current or warm water for a house.

5. The apparatus as defined in claim 1, wherein the device is a commercial food preparation unit or refrigerator.

6. The apparatus as defined in claim 1, wherein the device is a passenger car.

7. An apparatus for remote interrogation and/or remote control of operating states of a device (1) by a data service station (3) remote from the device with a temporary telephone connection between the data service station and a data interface of the device, wherein said apparatus comprises a data transmitter operating according to a “Bluetooth” principle and a commercially available mobile telephone provided with a “Bluetooth” interface for data transmission, said mobile telephone providing means for making the temporary telephone connection for the remote interrogation and/or remote control.

8. The apparatus as defined in claim 1, wherein the device is a household appliance or household entertainment device.

9. The apparatus as defined in claim 1, wherein the device is a heating plant for a house.

10. The apparatus as defined in claim 1, wherein the device is an apparatus for producing current or warm water for a house.

11. The apparatus as defined in claim 1, wherein the device is a commercial food preparation unit or refrigerator.

12. The apparatus as defined in claim 1, wherein the device is a passenger car.
